(19) United States
(12) Patent Application Publication
(10) Pub. No.: US 2020/0409343 A1
(43) Pub. Date: Dec. 31, 2020

(54) MACHINE TOOL SEARCH DEVICE, MACHINE TOOL SEARCH METHOD, AND MACHINE TOOL SEARCH PROGRAM

(71) Applicant: FANUC CORPORATION, Minamitsuru-gun (JP)

(72) Inventor: Nao Onose, Yamanashi (JP)

(21) Appl. No.: 16/901,521

(22) Filed: Jun. 15, 2020

(30) Foreign Application Priority Data
Jun. 26, 2019 (JP) 2019-118184

(51) Int. Cl. G05B 19/418; G06F 16/9035

(52) U.S. Cl. CPC G05B 19/4187; G05B 19/41845; G06F 16/9035; G05B 19/4188; G05B 19/41885

(57) ABSTRACT

It is desirable that an appropriate machine tool having functions desired by a user can be searched for easily. A machine tool search device includes: a collecting unit that collects information on functions included in each of a plurality of machine tools; an acquisition unit that acquires evaluation points of the functions; an extraction unit that extracts machine tools having a combination of the functions for satisfying search conditions when the search conditions are designated; a calculation unit that calculates an overall evaluation point on the basis of a sum of the evaluation points of the combination of functions and the evaluation points of functions other than the combination, included in each of the machine tools extracted by the extraction unit; and a determining unit that determines machine tools to be recommended for the search conditions on the basis of the overall evaluation point.

This application is based on and claims the benefit of priority from Japanese Patent Application No. 2019-118184, filed on 26 Jun. 2019, the content of which is incorporated herein by reference.

### BACKGROUND OF THE INVENTION

### Field of the Invention

The present invention relates to a device, a method, and a program for searching for a machine tool appropriate for machining conditions.

### Related Art

In recent years, the types, specifications, tools, and the like of machine tools used for machining parts have been diversified. Due to this, the finished conditions after machining in various machine tools differ depending on machining conditions such as the type and the material of the machining that a user wants to perform. In such a situation, it is desirable that a machine tool appropriate for desired machining conditions can be selected. Therefore, for example, Patent Document 1 proposes a technique of selecting a machining device capable of performing shaping based on design information of a product.
Patent Document 1: Japanese Patent No. 5894227

### SUMMARY OF THE INVENTION

However, when it is desired to search for a desired machine tool in a machine tool sharing service, an appropriate machine tool may not be extracted as a search result unless search conditions are input appropriately and in detail. Therefore, it is desirable that an appropriate machine tool having functions desired by a user can be searched for easily.

A machine tool search device according to an aspect of the present disclosure includes: a collecting unit that collects information on functions included in each of a plurality of machine tools; an acquisition unit that acquires evaluation points of the functions; an extraction unit that extracts machine tools having a combination of the functions for satisfying search conditions when the search conditions are designated; a calculation unit that calculates an overall evaluation point on the basis of a sum of the evaluation points of the combination of functions and the evaluation points of functions other than the combination, included in each of the machine tools extracted by the extraction unit; and a determining unit that determines machine tools to be recommended for the search conditions on the basis of the overall evaluation point.

A machine tool search method according to an aspect of the present disclosure causes a computer to execute: a collecting step of collecting information on functions included in each of a plurality of machine tools; an acquisition step of acquiring evaluation points of the functions; an extraction step of extracting machine tools having a combination of the functions for satisfying search conditions when the search conditions are designated; a calculation step of calculating an overall evaluation point on the basis of a sum of the evaluation points of the combination of functions and the evaluation points of functions other than the combination, included in each of the machine tools extracted in the extraction step; and a determining step of determining machine tools to be recommended for the search conditions on the basis of the overall evaluation point.

A machine tool search program according to an aspect of the present disclosure causes a computer to function as the machine tool search device.

According to an aspect, it is possible to easily search for an appropriate machine tool having functions desired by a user.

### BRIEF DESCRIPTION OF THE DRAWINGS

FIG. 1 is a system configuration diagram illustrating a use case of a machine tool search device according to an embodiment.

FIG. 2 is a block diagram illustrating a functional configuration of a machine tool search device according to an embodiment.

FIG. 3 is a diagram illustrating a first screen example for inputting machining conditions according to an embodiment.

FIG. 4 is a diagram illustrating a second screen example for inputting machining conditions according to an embodiment.

FIG. 5 is a diagram illustrating an evaluation point database according to an embodiment.

FIG. 6 is a diagram illustrating a method of calculating an overall evaluation point according to an embodiment.

FIG. 7 is a diagram illustrating an example in which search results are displayed together with a map according to an embodiment.

FIG. 8 is a diagram illustrating an example in which search results are displayed as a list according to an embodiment.

FIG. 9 is a diagram illustrating a display screen of detailed information of a machine tool according to an embodiment.

FIG. 10 is a diagram illustrating a post-use questionnaire input screen according to an embodiment.

FIG. 11 is a flowchart illustrating a machine tool search method according to an embodiment.

### DETAILED DESCRIPTION OF THE INVENTION

Hereinafter, a machine tool search device 1 configured as a management server in which pieces of information on a number of available machine tools are aggregated will be described as an example of an embodiment of the present invention.

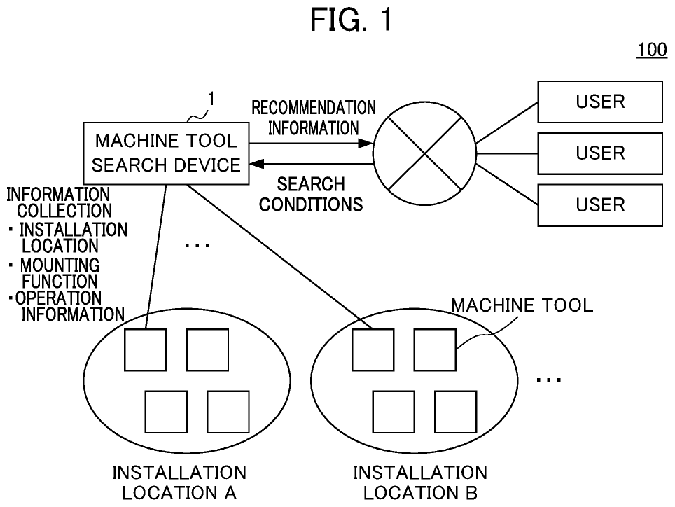

FIG. 1 is a system configuration diagram illustrating a use case of the machine tool search device 1 according to the present embodiment. In a search system 100, the machine tool search device 1 is connected to a management server of a plant or the like which is an installation location of a search target machine tool or a controller of a machine tool and receives access of users who use the search system 100 via a network such as the Internet.

The machine tool search device 1 collects an installation location, a mounting function, operation information, and the like as information related to each of a plurality of machine tools and stores the same in a prescribed database. When a user designates desired machining conditions as search conditions of the search system 100, the machine tool search device 1 extracts machine tools satisfying the designated machining conditions. Furthermore, the machine tool search device 1 presents recommendation information to the user, taking into account evaluations based on additional functions as well as the designated machining conditions as search results.

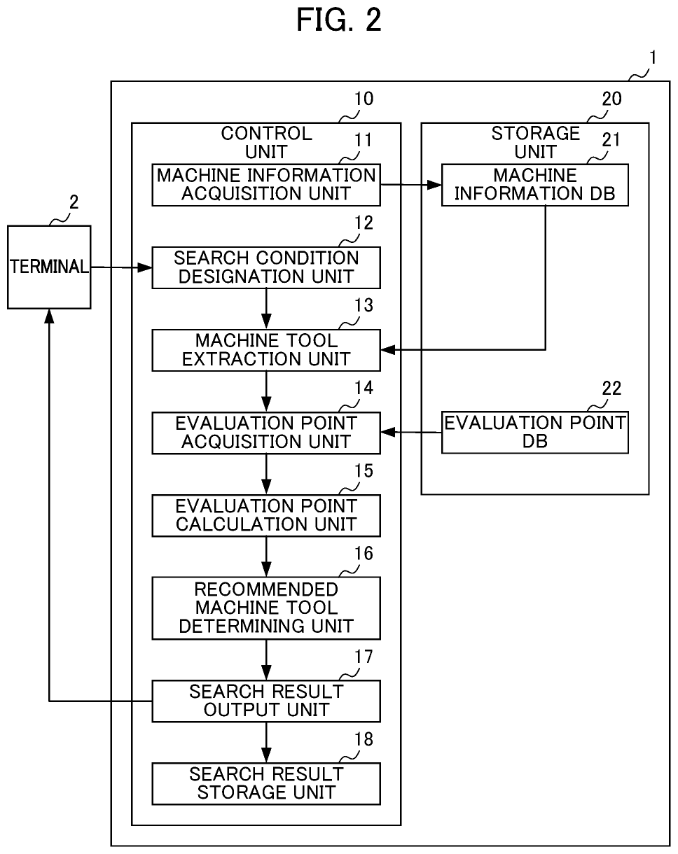

FIG. 2 is a block diagram illustrating a functional configuration of the machine tool search device 1 according to the present embodiment. The machine tool search device 1 is an information processing device including a control unit 10, a storage unit 20, and various input/output interfaces including a communication device. The machine tool search device 1 realizes various functions of the present embodiment by the control unit 10 executing software (a machine tool search program) stored in the storage unit 20.

The control unit 10 includes a machine information acquisition unit 11 (a collecting unit), a search condition. designation unit 12, a machine tool extraction unit 13 (an extraction unit), an evaluation point acquisition unit 14 (an acquisition unit), an evaluation point calculation unit 15 (a calculation unit), a recommended machine tool determining unit 16 (a determining unit), a search result output unit 17, and a search result storage unit 18. Moreover, the storage unit 20 stores a machine information database (DB) 21 and an evaluation point database 22 and provides the same to the control unit 10.

The machine information acquisition unit 11 collects function information of each of a plurality of machine tools serving as a search target. Furthermore, the machine information acquisition unit 11 may acquire operation information including an available date of a machine tool and the number of available machine tools and position information indicating the region or address or the like of an installation location in addition to the function information. Moreover, the machine information acquisition unit 11 may acquire catalog information including detailed specifications of a machine tool. These pieces of information may be held by each machine tool and be provided by communication and may be input to the machine tool search device 1 by users.

The collected information is stored in the machine information database 21 for respective machine tools. The machine information database 21 stores the function information defined for each machine tool together with unified standard terms, and these pieces of function information are correlated with terms of machining conditions selected or input from uses as search conditions and are registered as functions satisfying the machining conditions.

The search condition designation unit 12 receives desired machining conditions from a terminal 2 of a user who uses the search system 100 as search conditions for machine tools. In this case, the search condition designation unit 12 converts designated machining conditions to standard terms to generate a search expression by referring to a similar word dictionary prepared in advance.

The designated machining conditions may include at least any one of the pieces of information among a machining form, a machining program, a machining material, a manufacturer, design data, machining consumable quality, a region, a machine idling period, a production scale, a machine size, an expected machining time, a machining variation, and a user's evaluation.

The machining form is a classification such as, for example, cutting, grinding, or special machining. The machining program designates at least a portion of machining procedures that are to be executed actually, including G-codes. The machining material designates the material of a work which is a machining target, such as, for example, aluminum or plastics. The manufacturer designates a manufacturer of a machine tool or a controller thereof.

The design data is data such as, for example, CAD/CAM. The machining consumable quality designates a grade indicating a service life or a deterioration state of a tool, a coolant, or the like. The region designates the location of a plant where a machine tool is installed or a distance or the like from a present location. The machine idling period designates a period in which a machine tool is used.

The production scale designates the number of products to be produced, the number of machine tools, and the like, and for example, conditions such as 100 products for one machine tool or 50 products for each of two machine tools can be designated. The machine size designates conditions related to the size of a machining target, such as, for example, a maximum stroke, a table size, or the size of a material that can be machined.

The expected machining time designates the range of estimated time when it is possible to estimate the time required for machining using a machining program or the like. The machining variation designates the presence of optional items during machining, such as the presence of color variation during alumite machining, for example. The user's evaluation designates the content of evaluation input from a user who used a target machine tool in the past.

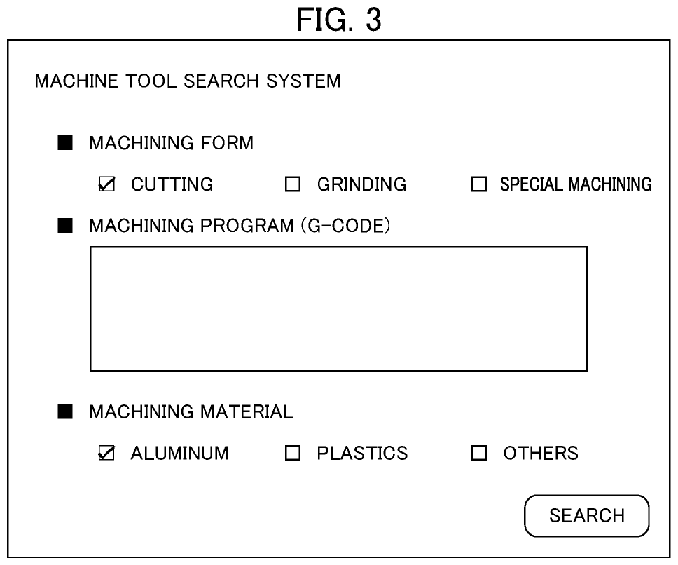

FIG. 3 is a diagram illustrating a first screen example for inputting machining conditions according to the present embodiment. In this example, a screen in which a machining form and a machining material are input as search conditions, and a machining program or a G-code is input.

The screen displayed on the terminal 2 of the user may be the screen of a dedicated application installed in the terminal and may be provided as a Web application of the machine tool search device 1 and be displayed by a WEB browser. The items of the search conditions are not limited thereto, and for example, the above-described various items may be disposed. Moreover, essential input, items may be set among the disposed items.

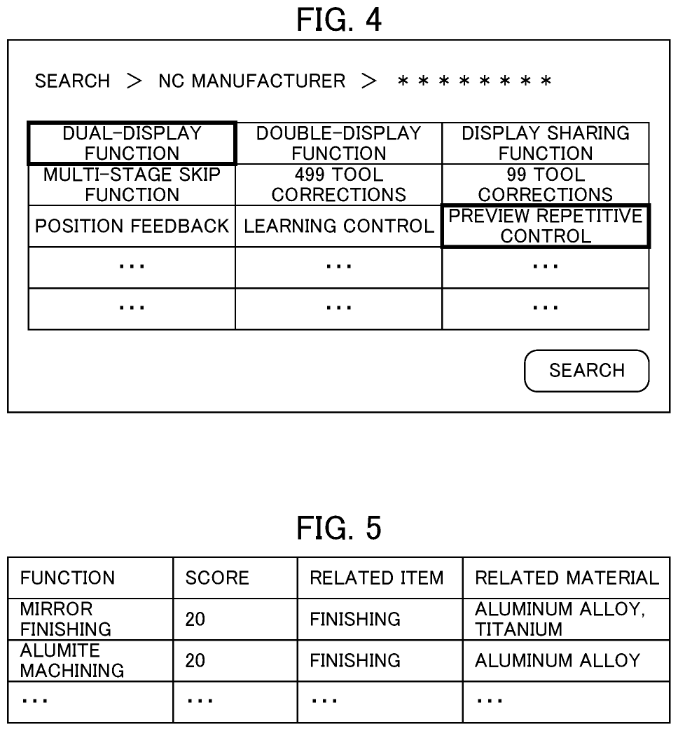

FIG. 4 is a diagram illustrating a second screen example for inputting machining conditions according to the present embodiment. In this example, a state in which a manufacturer of a controller is selected as a search condition is illustrated. Furthermore, functions of any one of controllers of a selected manufacturer are presented as options. A user selects a desired function among these options as a search condition.

When a machining condition is designated, the machine tool extraction unit 13 extracts a machine tool having a combination of functions for satisfying the machining condition by referring to the machine information database 21.

The evaluation point acquisition unit 14 acquires an evaluation point of each of the functions of the machine tool extracted by the machine tool extraction unit 13 from the evaluation point database 22. In this case, the evaluation point database 22 stores evaluation points defined in advance for respective functions.

FIG. 5 is a diagram illustrating the evaluation point database 22 according to the present embodiment. In the evaluation point database 22, an evaluation point (score) is set for each function like twenty scores for mirror finishing, for example. In this case, a function field is described in a standard term in a unified manner and is correlated with the machine information database 21.

Although machine tools have the same functions in standard terms, the evaluation points of the machine tools may be different from each other. That is, an evaluation point may be set for each machine tool and for each function.

Moreover, individual functions are correlated with each other, and groups made up of a plurality of functions are set according to a related item, a related material, or the like. For example, a related item indicates a certain step among a series of machining procedures such as “finishing”, and a related material indicates a material of a machining target such as “aluminum alloy”. Functions belonging to the same group among the essential functions satisfying the machining conditions designated by the user are additional functions that the user is likely to desire.

The evaluation point calculation unit 15 calculates an overall evaluation point on the basis of the sum of evaluation points of a combination of essential functions for satisfying the machining conditions and evaluation points of additional functions other than essential functions for respective machine tools extracted by the machine tool extraction unit 13. In this case, the evaluation point calculation unit 15 calculates an overall evaluation point of functions related to designated machining conditions, of a machine tool on the basis of the evaluation points of respective functions included in the combination of essential functions and the evaluation points of additional functions correlated in advance in the evaluation point database 22.

Moreover, when the sum of the evaluation points of the essential functions does not reach a prescribed reference point, the evaluation point calculation unit 15 calculates the overall evaluation point on the basis of the reference point and the evaluation points of the additional functions. That is, a machine tool satisfying machining conditions is given a reference point even when the sum of evaluation points of essential functions does not actually reach the reference point.

In this case, the evaluation point calculation unit 15 may calculate the overall evaluation point by applying different weightings to the evaluation points of the essential functions and the evaluation points of the additional functions. In this case, the evaluation point calculation unit 15 may adjust the weighting to the evaluation points of the additional functions according to a difference between the reference point and the sum of the evaluation points of the essential function. Specifically, for example, when a standard weighting coefficient is 0.5, the coefficient is changed to 0.3 if the sum of the evaluation points of essential functions exceeds the reference point whereas the coefficient is changed to 0.7 if the sum does not reach the reference point. A threshold for changing the coefficient may be set appropriately. Moreover, when the sums of evaluation points of the essential functions of respective machine tools are not the same, a weighting coefficient common to all machine tools may be determined on the basis of the highest evaluation point.

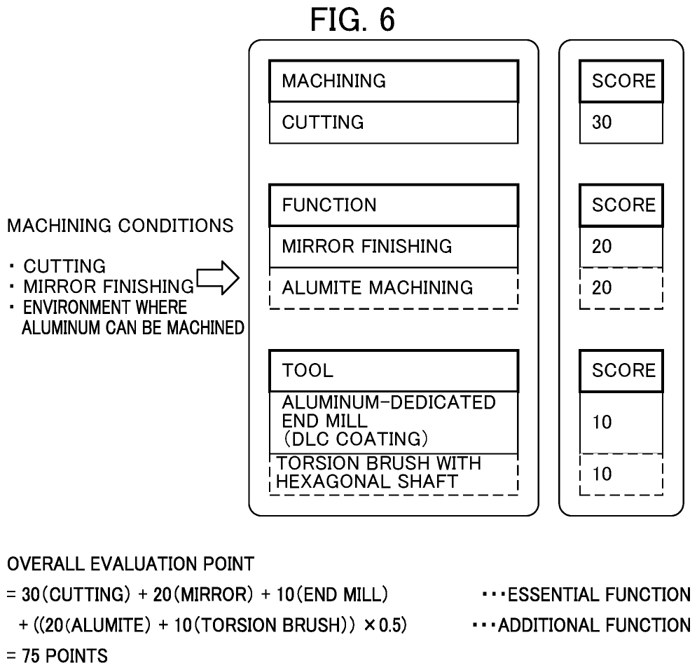

FIG. 6 is a diagram illustrating a method of calculating an overall evaluation point according to the present embodiment. In this example, related functions of the extracted machine tools when the machining conditions designated by a user are “cutting”, “mirror finishing”, and “environment where aluminum can be machined” and the evaluation points set to respective functions are illustrated.

In this case, 30 points of cutting, 20 points of mirror finishing, and 10 points of aluminum-dedicated end mill are added as evaluation points for essential functions for satisfying the machining conditions. Moreover, a score obtained by multiplying the sum of 20 points of alumite machining and 10 points of torsion brush by a weighting coefficient of 0.5 is added as the evaluation points of related additional functions.

Moreover, the evaluation point calculation unit 15 may adjust the overall evaluation point on the basis of an expected machining time of the machine tools extracted by the machine tool extraction unit. Specifically, the overall evaluation point may be adjusted to a higher value as the expected machining time decreases. For example, the evaluation point calculation unit 15 sorts the machine tools capable of executing a machining program entered in the search conditions according to the expected machining time and then adjusts the overall evaluation point according to the percentage of a rank with respect to a total number of machine tools. For example, the overall evaluation point can be adjusted such that the evaluation point is increased by 10 points if the score is within the top 20%, the evaluation point is increased by 5 points if the score is in the range of the top 21% to the top 50%, the evaluation point is not changed if the score is in the range of the top 51% to the top 75%, and the evaluation point is decreased by 5 points if the score is in the range of the top 76% to the top 100%.

Furthermore, the evaluation point calculation unit 15 may adjust the overall evaluation point so that a machine tool of which the distance from the present location of a user or a designated position is short or a machine tool of which the number of days to an available date is small is used preferentially.

The recommended machine tool determining unit 16 determines machine tools to be recommended to a user for the search conditions on the basis of the overall evaluation points calculated for respective machine tools. Specifically, for example, a prescribed number of machine tools of which the overall evaluation points are on the top ranks or machine tools of which the overall evaluation points exceed a prescribed threshold may be selected. In this case, an overall evaluation point may be converted to a recommendation level represented by the number of stars in which five stars correspond to the highest level. For example, thresholds are set appropriately such that one star is assigned for an overall evaluation point of 0 to 24 points, two stars are assigned for an overall evaluation point of 25 to 49 points, three stars are assigned for an overall evaluation point of 50 to 69 points, four stars are assigned for an overall evaluation point of 70 to 84 points, and five stars are assigned for an overall evaluation point of 85 points or more.

The search result output unit 17 outputs information on machine tools determined by the recommended machine tool determining unit 16 to the terminal 2 of the user as search results for search conditions.

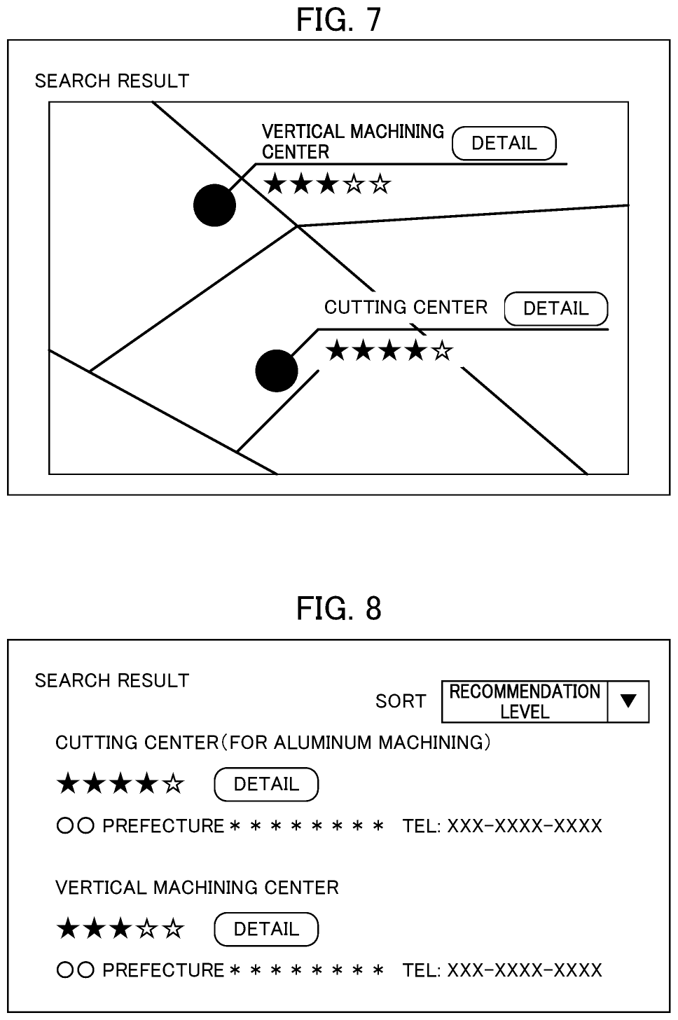

FIG. 7 is a diagram illustrating an example in which search results are displayed together with a map according to the present embodiment. In this example, information on a machine tool having the highest recommendation level is displayed on a map. In this case, for example, machine tools present within a prescribed distance from a present location or present in a designated region may be selected.

FIG. 8 is a diagram illustrating an example in which search results are displayed as a list according to the present embodiment. In this example, pieces of information on machine tools are displayed as a list in descending order of recommendation levels (that is, overall evaluation points). A display order can be designated appropriately such as ascending order of distances from a present location or a designated position or ascending order of number of days to an available date in addition to the descending order of overall evaluation points.

When a detail button on a display screen of search results is pressed, the machine tool search device 1 provides detailed information such as catalog information related to the corresponding machine tool to the terminal 2 of the user and displays the same on a screen by referring to the machine information database 21.

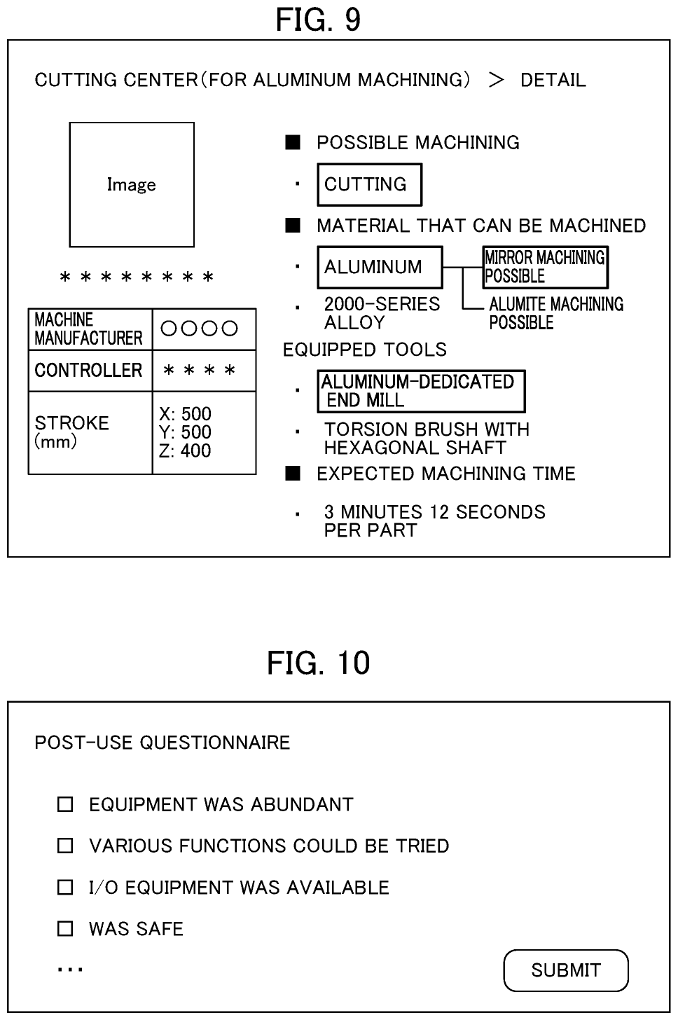

FIG. 9 is a diagram illustrating a display screen of detailed information of a machine tool according to the present embodiment. In this example, a possible machining form, a material that can be machined, equipped tools, an expected machining time are displayed together with catalog information including detailed specifications of a machine tool.

The machining conditions designated by a user are displayed in an emphasized manner. Furthermore, additional functions related to the designated machining conditions, such as alumite machining which is an additional function grouped by a related material (aluminum) are also displayed.

A function name to be displayed may be an expression unique to respective machine tools and may be displayed in a standard term. Alternatively, both terms may be displayed as a pair.

The search result storage unit 18 stores history information related to search results in the machine information database 21. The history information includes, for example, machining conditions designated as search conditions, essential functions and additional functions counted into the overall evaluation point, the content of a questionnaire related to machine tools used actually after search, and functions of machine tools used.

The history information stored in this manner is used in the order of displaying functions on a machining condition input screen (for example, FIG. 4). For example, a frequently used function, a designated function, or the like may be displayed above.

FIG. 10 is a diagram illustrating a post-use questionnaire input screen according to the present embodiment. In this example, a user who has actually used a machine tool selects a corresponding item among a plurality of items provided in advance. In this way, the evaluations of users are accumulated for respective machine tools and can be used as search conditions.

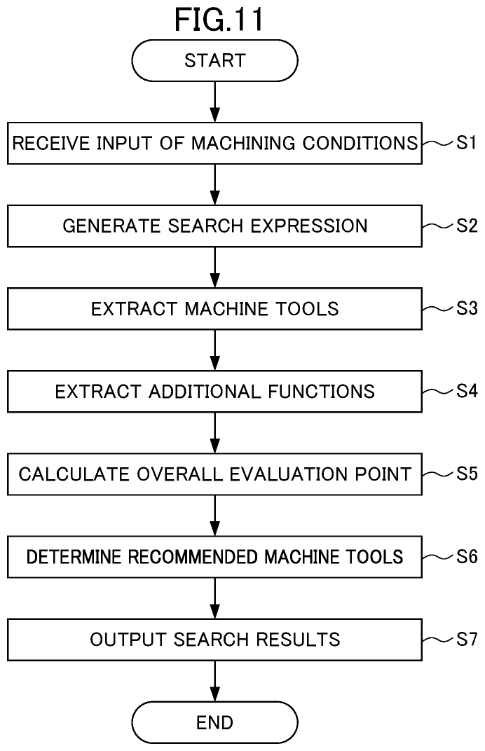

FIG. 11 is a flowchart illustrating a machine tool search method according to the present embodiment. In this example, it is assumed that the machine information database 21 and the evaluation point database 22 have been constructed in advance.

In step S1, the search condition designation unit 12 receives the input of desired machining conditions from the terminal 2 of a user.

In step S2, the search condition designation unit 12 generates a search expression using standard terms on the basis of the input machining conditions.

In step S3, the machine tool extraction unit 13 searches the machine information database 21 on the basis of the generated search expression and extracts machine tools having a combination of essential functions for satisfying all the designated desired machining conditions.

In step S4, the evaluation point calculation unit 15 extracts additional functions related to essential functions for respective extracted machine tools.

In step S5, the evaluation point calculation unit 15 calculates an overall evaluation point of each machine tool on the basis of the evaluation points of the essential functions and the evaluation points of the additional functions.

In step S6, the recommended machine tool determining unit 16 determines machine tools recommended to a user on the basis of the overall evaluation point.

In step S7, the search result output unit 17 outputs information on the determined machine tools and presents the same to the user as search results for the search conditions.

According to the present embodiment, the following effects are obtained, for example.

(1) A machine tool search device 1 includes: a machine information acquisition unit 11 that collects information on functions included in each of a plurality of machine tools; an evaluation point acquisition unit 14 that acquires evaluation points of the functions; a machine tool extraction unit 13 that extracts machine tools having a combination of the functions for satisfying search conditions when the search conditions are designated; an evaluation point calculation unit 15 that calculates an overall evaluation point on the basis of a sum of the evaluation points of the combination of functions and the evaluation points of functions other than the combination, included in each of the machine tools extracted by the machine tool extraction unit 13; and a recommended machine tool determining unit 16 that determines machine tools to be recommended for the search conditions on the basis of the overall evaluation point.

Due to this, the machine tool search device 1 outputs machine tools having higher evaluation points of additional functions among the machine tools satisfying the machining conditions designated as search conditions as search results. Therefore, the machine tool search device 1 can reduce the labor in selecting a machine tool and can search for better and more appropriate machine tools having functions desired by users. Moreover, a business operator who owns machine tools and provides a sharing service can allocate appropriate users to machine tools and operate the service efficiently by collecting function information of machine tools in the machine tool search device 1. Furthermore, by operating a system including the machine tool search device 1, it is possible to collect big data such as the trend of functions used by users, a popular material, and the scale of machining.

(2) In the machine tool search device 1 according to (1), the evaluation point calculation unit 15 may calculate the overall evaluation point on the basis of the evaluation points of the functions included in the combination and the evaluation points of functions other than the combination correlated in advance with the functions included in the combination.

Due to this, the machine tool search device 1 counts the evaluation points of additional functions related to essential functions as well as essential functions satisfying the machining conditions into the overall evaluation point. Therefore, the machine tool search device 1 can recommend functions that may be necessary although they are not designated in the machining conditions or better functions to the user and can present more appropriate machine tools to the user.

(3) In the machine tool search device 1 according to (1) or (2), the evaluation point calculation unit 15 may calculate the overall evaluation point on the basis of a prescribed reference point and the evaluation points of functions other than the combination when the sum of the evaluation points of the functions included in the combination does not reach the reference point.

Due to this, the machine tool search device 1 can prevent the overall evaluation point from decreasing although the machining conditions designated by the user are satisfied and can prevent machine tools having sufficient functions from being excluded from search results.

(4) In the machine tool search device 1 according to any one of (1) to (3), the evaluation point calculation unit 15 may apply different weightings to the evaluation points of the functions included in the combination and the evaluation points of functions other than the combination to calculate the overall evaluation point.

Due to this, the machine tool search device 1 can provide a difference in weighting between essential functions and additional functions and can recommend machine tools on the basis of an appropriate overall evaluation point.

(5) In the machine tool search device 1 according to (3), the evaluation point calculation unit 15 may adjust the weighting for the evaluation points of the functions other than the combination according to a difference between the reference point and the sum of the evaluation points of the functions included in the combination.

Due to this, the machine tool search device 1 can increase the difference in overall evaluation point between machine tools when the additional functions are different from machine tool to machine tool by changing the weighting for the evaluation points of additional functions. As a result, the user can make determination easily since a clear difference occurs between the recommendation levels provided to the user for respective machine tools.

(6) in the machine tool search device 1 according to any one of (1) to (5), the search conditions may include at least any one of pieces of information among a machining form, a machining program, a machining material, a manufacturer, design data, quality of machining consumables, a region, a machine idling period, a production scale, a machine size, an expected machining time, a machining variation, and a user's evaluation.

Due to this, the user can designate various machining conditions depending on a situation, and the machine tool search device 1 can search for appropriate machine tools according to the machining conditions and can recommend the same to the user.

(7) In the machine tool search device 1 according to any one of (1) to (6), the evaluation point calculation unit 15 may adjust the overall evaluation point on the basis of an expected machining time when the machine tools extracted by the machine tool extraction unit 13 are used.

Due to this, the machine tool search device 1 can calculate an overall evaluation point so that a machine tool capable of completing machining at a higher speed has a higher overall evaluation point and can recommend the same to the user preferentially.

While the embodiments of the present invention have been described, the present invention is not limited to the above-described embodiments. The effects described in the present embodiment are only examples of most preferable effects produced by the present invention, and the effects of the present invention are not limited to those described in the present embodiment.

The machine tool search device 1 of the present embodiment may be configured as a cloud server. Moreover, in the present embodiment, although various databases are stored in the storage unit 20 of the machine tool search device 1, there is no limitation thereto and the databases may be stored in an external device.

The machine tool search method by the machine tool search device 1 is realized by software. When the machine tool search method is realized by software, programs that form the software are installed on a computer. Moreover, these programs may be recorded on a removable medium and be distributed to a user and may be distributed by being downloaded to a computer of the user via a network.

### EXPLANATION OF REFERENCE NUMERALS

1: Machine tool search device
2: Terminal
10: Control unit
11: Machine information acquisition unit
12: Search condition designation unit
13: Machine tool extraction unit
14: Evaluation point acquisition unit
15: Evaluation point calculation unit
16: Recommended machine tool determining unit
17: Search result output unit
18: Search result storage unit
20: Storage unit
21: Machine information database
22: Evaluation point database
100: Search system

What is claimed is:

1. A machine tool search device comprising:
a collecting unit that collects information on functions included in each of a plurality of machine tools;
an acquisition unit that acquires evaluation points of the functions;
an extraction unit that extracts machine tools having a combination of the functions for satisfying search conditions when the search conditions are designated;
a calculation unit that calculates an overall evaluation point on the basis of a sum of the evaluation points of the combination of functions and the evaluation points of functions other than the combination, included in each of the machine tools extracted by the extraction unit; and
a determining unit that determines machine tools to be recommended for the search conditions on the basis of the overall evaluation point.

2. The machine tool search device according to claim 1, wherein
the calculation unit calculates the overall evaluation point on the basis of the evaluation points of the functions included in the combination and the evaluation points of functions other than the combination correlated in advance with the functions included in the combination.

3. The machine tool search device according to claim 1, wherein
the calculation unit calculates the overall evaluation point on the basis of a prescribed reference point and the evaluation points of functions other than the combination when the sum of the evaluation points of the functions included in the combination does not reach the reference point.

4. The machine tool search device according to claim 1, wherein
the calculation unit applies different weightings to the evaluation points of the functions included in the combination and the evaluation points of functions other than the combination to calculate the overall evaluation point.

5. The machine tool search device according to claim 3, wherein
the calculation unit adjusts the weighting for the evaluation points of the functions other than the combination according to a difference between the reference point and the sum of the evaluation points of the functions included in the combination.

6. The machine tool search device according to claim 1, wherein
the search conditions include at least any one of pieces of information among a machining form, a machining program, a machining material, a manufacturer, design data, quality of machining consumables, a region, a machine idling period, a production scale, a machine size, an expected machining time, a machining variation, and a user's evaluation.

7. The machine tool search device according to claim 1, wherein
the calculation unit adjusts the overall evaluation point on the basis of an expected machining time when the machine tools extracted by the extraction unit are used.

8. A machine tool search method for causing a computer to execute:
a collecting step of collecting information on functions included in each of a plurality of machine tools;
an acquisition step of acquiring evaluation points of the functions;
an extraction step of extracting machine tools having a combination of the functions for satisfying search conditions when the search conditions are designated;
a calculation step of calculating an overall evaluation point on the basis of a sum of the evaluation points of the combination of functions and the evaluation points of functions other than the combination, included in each of the machine tools extracted in the extraction step; and
a determining step of determining machine tools to be recommended for the search conditions on the basis of the overall evaluation point.

9. A non-transitory computer-readable medium having recorded thereon a machine tool search program for causing a computer to function as the machine tool search device according to claim 1.
